(19) United States
(12) Patent Application Publication
(10) Pub. No.: US 2010/0209171 A1
(43) Pub. Date: Aug. 19, 2010

(54) Two in one pen with pencil graphite and refill ball pen

(76) Inventor: Kung Yuan Tong, Suwanee, GA (US)

Correspondence Address: Kun Yuan Tong, 2842 Lowe Court, Suwanee, GA, 30024, US

(21) Appl. No.: 12/378,602

(22) Filed: Feb. 18, 2009

(51) Int. Cl. B43K 27/02

(52) U.S. Cl. 401/32

(57) ABSTRACT

Two in one pen with pencil graphite and refill ball pen is a pen which has installed pencil graphite at one side and refill ball pen at the other. User can switch from pencil to ball pen at his/her wish in a second and vice versa to write.

### THE BACKGROUND OF THE INVENTION

In our daily lives sometimes we use pencil to write and sometimes we use ball pen to write. Therefore we have to carry one pencil and one ball pen. One two in one pen with pencil graphite and refill ball pen enable us to write with pencil graphite or refill ball pen.

### THE BRIEF SUMMARY OF THE INVENTION

Two in one pen with pencil graphite and refill ball pen has installed pencil graphite and refill ball pen in one pen. Therefore we carry only one of it and can write with pen graphite or refill ball pen.

### THE DETAILED DESCRIPTION OF THE DRAWINGS

FIG. 1 is a perspective view of two in one pen with pencil graphite and refill ball pen.

FIG. 2 is a perspective view of parts of two in one pen with pencil graphite and refill ball pen.

FIG. 3 is dissection view of parts of two in one pen with pencil graphite and refill ball pen.

### THE DETAILED DESCRIPTION OF THE INVENTION

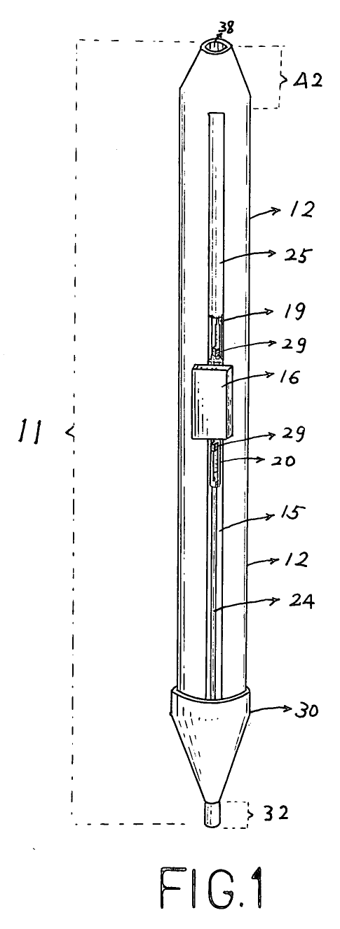

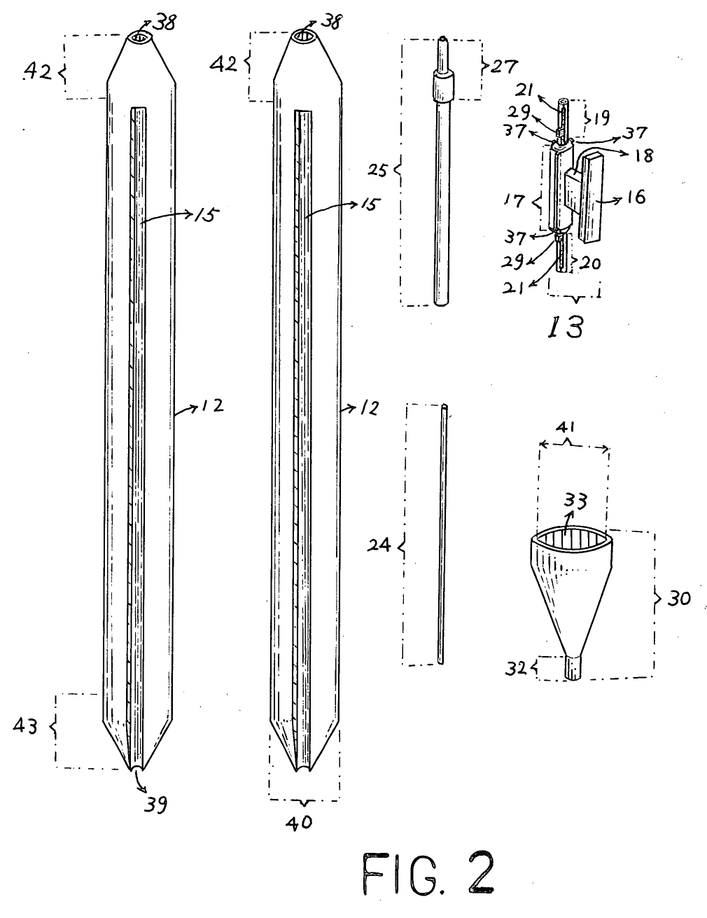

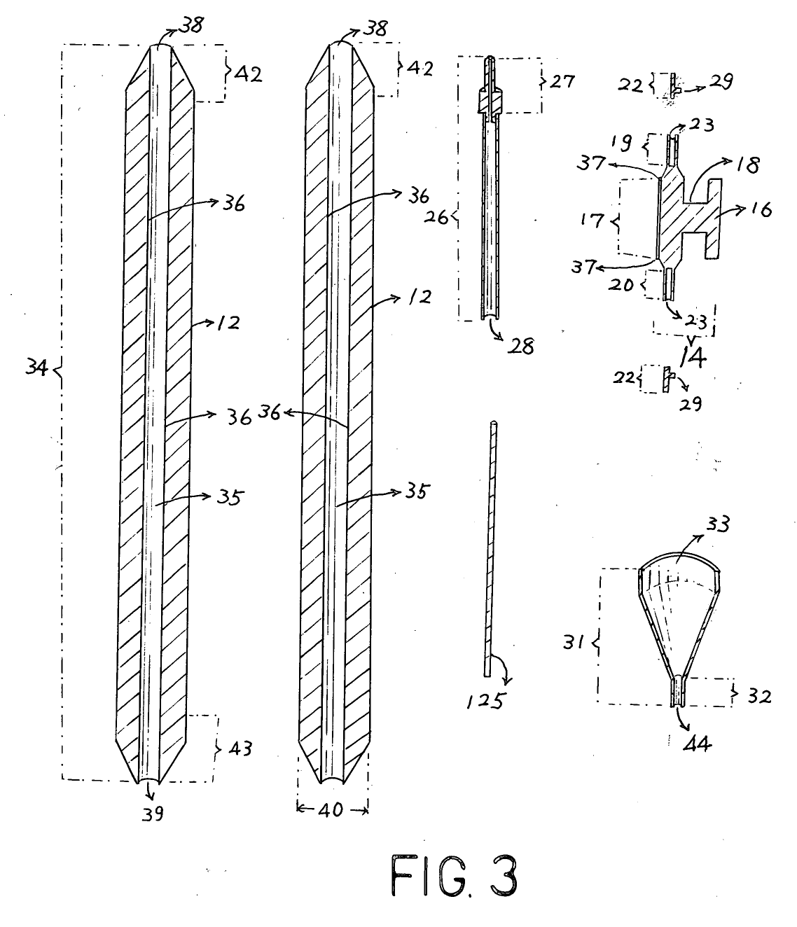

Referring now in detail to the drawings numeral 11 of FIG. 1 is two in one pen with pencil graphite and refill ball pen. Numeral 12 of FIGS. 1, 2 and 3 is pen stalk. Numeral 13 of FIG. 2 is slider. Numeral 14 of FIG. 3 is dissection view of slider 13. Numeral 15 of FIGS. 1 and 2 is stalk slot. Numeral 16 of FIGS. 1, 2 and 3 is slider handle. Numeral 17 of FIGS. 2 and 3 is slider body. Numeral 18 of FIGS. 2 and 3 is slider stalk. Slider stalk 18 of FIGS. 2 and 3 can slide in stalk slot 15 of FIGS. 1 and 2. Numeral 19 of FIGS. 1, 2 and 3 is upper holder. Numeral 20 of FIGS. 1, 2 and 3 is lower holder. Upper holder 19 of FIGS. 2 and 3 and lower holder 20 of FIGS. 2 and 3 can be identical. Numeral 21 of FIG. 2 is holder slot. Holder slot 21 of FIG. 2 is enclosed slot. Numeral 22 of FIG. 3 is pusher. Numeral 23 of FIG. 3 is graphite canal. Pusher 22 of FIG. 2 is installed inside graphite canal 23 of FIG. 3. Pusher 22 of FIG. 3 slides freely inside graphite canal 23 of FIG. 3. Numeral 24 of FIGS. 1 and 2 is pencil graphite. Numeral 25 of FIG. 2 is refill ball pen. Numeral 26 of FIG. 3 is dissection view of refill ball pen 25 of FIG. 2. Numeral 27 of FIGS. 2 and 3 is ball pen tip. Numeral 28 of FIG. 3 is canal of refill ball pen 25 of FIG. 2. Holder 19 and 20 of FIGS. 2 and 3 can insert with small resistance into canal 28 of refill ball pen 26 of FIG. 3. Numeral 29 of FIGS. 1, 2 and 3 is handle of pusher 22. Handle 29 of pusher 22 of FIG. 3 can slide loosely in holder slot 21 of FIG. 2. Pencil graphite 24 of FIG. 2 can insert with small resistance into graphite canal 23 of FIG. 3 and stays inside graphite canal 23 of holder 19 and 20 of FIG. 3. User can push handle 29 of FIGS. 2 and 3 of pusher 22 of FIG. 3 outward to push pencil graphite 24 of FIG. 2 out of graphite canal 23 of FIG. 3. Numeral 30 of FIGS. 1 and 2 is graphite protecting cover. Numeral 31 of FIG. 3 is the dissection view of graphite protecting cover 30 of FIG. 2. Numeral 32 of FIGS. 1, 2 and 3 is graphite protecting tube. Numeral 33 of FIGS. 2 and 3 is upper opening of graphite protecting cover 30 of FIG. 2. Numeral 34 of FIG. 3 is dissection view of pen stalk 12 of FIGS. 1 and 2. Numeral 35 of FIG. 3 is central stalk canal of pen stalk 12 of FIGS. 1 and 2. Numeral 36 of FIG. 3 is wall of central stalk canal 35. Numeral 37 of FIGS. 2 and 3 is slider ridge of slider 13 of FIGS. 2 and 3. The diameter of slider 13 with its slider ridge 37 of FIGS. 2 and 3 is determined to create a moderate degree of resistance when it slides inside central stalk canal 35 of FIG. 3 to prevent pencil graphite 24 of FIGS. 1 and 2 or refill ball pen 25 of FIGS. 1,2 and 3 from retracting into central stalk canal 35 of FIG. 3 while writing. Numeral 38 of FIGS. 1, 2 and 3 is upper opening of central stalk canal 35. Numeral 39 of FIGS. 2 and 3 is lower opening of central stalk canal 35 of FIGS. 1, 2 and 3. Numeral 40 of FIGS. 2 and 3 is the diameter of pen stalk 12. Numeral 41 of FIG. 2 is the diameter of upper opening 33 of graphite protecting cover 30 of FIG. 2. Diameter 40 of pen stalk 12 of FIGS. 2 and 3 is equal to diameter 41 of graphite protecting cover 30 of FIG. 2. Numeral 42 of FIGS.. 1, 2 and 3 is upper end of pen stalk 12 of FIGS. 1, 2 and 3. Numeral 43 of FIGS. 2 and 3 is lower end of pen stalk 12 of FIGS. 2 and 3. Numeral 44 of FIG. 3 is canal of graphite protecting tube 32 of FIG. 3. Pencil graphite 24 of FIGS. 1 and 2 can slide snugly and freely inside canal 44 of graphite protecting tube 32 of FIG. 3. Graphite protecting cover 30 of FIG. 2 can cover tightly upper end 42 of FIGS. 1,2 and 3 or lower end 43 of FIGS. 2 and 3. Numeral 125 of FIG. 3 is dissection view of pencil graphite 24 of FIGS. 1 and 2. The way to assemble two in one pen with pencil graphite and refill ball pen 11 of FIG. 1 is as follows: The first step is to insert upper holder 19 of FIG. 2 into canal 28 of FIG. 3 of refill ball pen 26 of FIG. 3. The second step is to insert pencil graphite 24 of FIG. 2 into graphite canal 23 of FIG. 3 of lower holder 20 of FIG. 3.The third step is to insert ball pen tip 27 of refill ball pen 25 of FIG. 2 into lower opening 39 of central stalk canal 35 of FIG. 3 and to advance refill ball pen 25 into central stalk canal 35 of FIG. 3. The forth step is to insert slider stalk 18 of slider 13 of FIG. 2 into stalk slot 15 of FIGS. 1 and 2 and to push upward slider handle 16 of slider 13 of FIG. 2 to slide slider 13 up to the middle portion of pen stalk 12 of FIGS. 1, 2 and 3 to drag pencil graphite 24 of FIG. 2 inside central stalk canal 35 of pen stalk 12 FIG. 3. The last step is to cover lower end 43 of FIGS. 2 and 3 of pen stalk 12 of FIGS. 1, 2 and 3 with graphite protecting cover 30 of FIG. 2. If upper end 42 of pen stalk 12 of FIGS. 1, 2 and 3 is covered with a graphite protecting cover 30 of FIG. 2 then another pencil graphite 24 of FIG. 2 can insert into graphite canal 23 of upper holder 19 to be used as a pencil. If graphite protecting cover 30 of FIG. 2 is removed from lower end 43 of FIGS. 1, 2 and 3 of pen stalk 12 of FIG. 2 then a refill ball pen 25 of FIG. 2 can admit lower holder 20 of slider 13 of FIG. 2 to be used as a ball pen.

1. Two in one pen with pencil graphite and refill ball pen comprising a hollow pen stalk, a slider, a pencil protecting cover, a pencil graphite and a refill ball pen.

2. Two in one pen with pencil graphite and refill ball pen of claim 1 wherein said hollow pen stalk is a long stalk which has a central canal which is throughout the whole pen stalk, two cone-shaped ends and one side slot which has one open end through the end of one of said cone-shaped end and one closed end which is near the end of another said cone-shaped end. Wherein said side slot has a width which is smaller than the diameter of said central canal.

3. Two in one pen with pencil graphite and refill ball pen of claim 1 wherein said slider is a H-shaped structure which has one outer skateboard like side board to be used for pushing up and down, one inner cylinder which has ridges on its side wall and two small terminal tubes which locate at center of each end of said inner cylinder and a central connector. Wherein said ridges contact tightly with wall of said central canal of claim 2 and can slide inside said central canal with some degree of friction. Wherein said small terminal tube can insert into said refill ball pen of claim 1 and also can admit pencil graphite of claim 1. Wherein said central connector is a connector which connects said outer skateboard like side board and inner cylinder and can slide smoothly in said side slot of claim 2.

4. Two in one pen with pencil graphite and refill ball pen of claim 1 wherein said pencil protecting cover is a cone-shaped cover which has a apex, a middle cone-shaped tube and a basal end. Wherein said apex has a small central tube which can admit and protects said pencil graphite of claims 1 and 3. Wherein said middle cone-shaped tube is at the middle of said cone-shaped cover. Wherein said basal end is a cylindrical tube which admits and covers tightly either one of said cone-shape end of claim 2.

5. Two in one pen with pencil graphite and refill ball pen of claim 1 wherein said pencil graphite is a fine pencil graphite which can insert into any one of said small terminal tubes of said inner cylinder of claim 3.

6. Two in one pen with pencil graphite and refill ball pen of claim 1 wherein said refill ball pen can admit any one of said small terminal tube of said inner cylinder of claim 3.
